(19) United States
(12) Patent Application Publication
(10) Pub. No.: US 2018/0359173 A1
(43) Pub. Date: Dec. 13, 2018

(54) INFORMATION PROCESSING DEVICE, INFORMATION PROCESSING METHOD, AND NON-TRANSITORY COMPUTER-READABLE STORAGE MEDIUM

(71) Applicant: FUJITSU LIMITED, Kawasaki-shi (JP)

(72) Inventor: Yoshinori Tomita, Yokohama (JP)

(73) Assignee: FUJITSU LIMITED, Kawasaki-shi (JP)

(21) Appl. No.: 16/000,936

(22) Filed: Jun. 6, 2018

(30) Foreign Application Priority Data
Jun. 8, 2017 (JP) 2017-113457

(51) Int. Cl. H04L 12/721; H04L 12/755; H04L 12/723; H04L 12/707

(52) U.S. Cl. CPC H04L 45/124; H04L 45/22; H04L 45/505; H04L 45/021

(57) ABSTRACT

A method, performed by a computer for controlling a communication path among a plurality of processing units, includes: executing an acquiring process that includes acquiring communication cost of communication paths among the plurality of processing units; and executing an adding control process that includes performing control to add a bypass communication path which connects a first processing unit and a second processing unit, each of the first and second processing unit being any of the plurality of processing units, and the communication cost of a communication path between the first and second processing units being higher than a first threshold value.

### CROSS-REFERENCE TO RELATED APPLICATION

This application is based upon and claims the benefit of priority of the prior Japanese Patent Application No. 2017-113457, filed on Jun. 8, 2017, the entire contents of which are incorporated herein by reference.

### FIELD

The embodiments discussed herein are related to an information processing device, an information processing method, and a non-transitory computer-readable storage medium.

### BACKGROUND

A communication method among cells has been disclosed in which each cell of plural cells is connected with a portion of neighboring cells via a connection line and the cell to be a transmission source sequentially outputs route designation information which designates the cell to be a transmission destination. Each of the cells interprets the received route designation information, sequentially selects the neighboring cell that is connected by the connection line, and thereby decides a communication route between the cells. Each of the cells that receive the route designation information replaces the route designation information, which is assigned to the cell, with the route designation information, which is assigned to the following cell, in accordance with the state of the connection line that is designated by the route designation information and thereby decides the communication route.

Further, a network route setting method among nodes of a network has been disclosed which decides cost functions to be taken into consideration in selection of the route, provides respective priorities of the cost functions, and thereby generates a complex multi-cost function. As a connection matrix, a connection matrix is decided which corresponds to a network which includes the combination formed with n elements provided with orders which directly express respective multi-costs of pairs of nodes in the network. A general addition operator is defined such that distribution characteristics and exchange characteristics are applicable to the general addition total of values of the cost functions. Those general addition operator and orders are used to apply the complex multi-cost function to the connection matrix, and the shortest route matrix is thereby derived.

Examples of the related art include Japanese Laid-open Patent Publication No. 11-297834 and Japanese Laid-open Patent Publication No. 10-161994.

### SUMMARY

According to an aspect of the present description, a method performed by a computer for controlling a communication path among a plurality of processing units includes: executing an acquiring process that includes acquiring communication cost of communication paths among the plurality of processing units; and executing an adding control process that includes performing control to add a bypass communication path which connects a first processing unit and a second processing unit, each of the first and second processing unit being any of the plurality of processing units, and the communication cost of a communication path between the first and second processing units being higher than a first threshold value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram that illustrates a configuration example of an information processing system according to a first embodiment

FIG. 2A is a diagram that illustrates a configuration example of a processing unit and FIG. 2B is a diagram that illustrates a configuration example of ports of the processing unit.

FIG. 3 is a diagram that illustrates an example of a packet which is transmitted by the processing unit.

FIG. 4 is a diagram that illustrates examples of initial values of a routing table of the processing unit.

FIG. 5 is a diagram that illustrates an example where a bypass communication path is connected between the processing units.

FIG. 6 is a diagram that illustrates an example of the routing table in a case where the bypass communication path is added.

FIG. 7 is a diagram for explaining a method in which an information processing device generates the routing table.

FIG. 8 is a diagram for explaining a method in which the processing unit decides the port for transmission.

FIG. 9 is a diagram that illustrates an example of a communication time table which is generated by a transmission destination processing unit.

FIG. 10 is a diagram that illustrates an example of a communication time table which is generated by the information processing device.

FIGS. 11A and 11B are flowcharts that illustrate an information processing method of the information processing device.

FIG. 12 is a diagram that illustrates an example of a communication amount table which is generated by each of the processing units according to a second embodiment.

FIG. 13 is a diagram that illustrates an example of a communication amount table which is generated by the information processing device.

FIG. 14A is a diagram that illustrates an example of a coefficient table, and FIG. 14B is a graph that represents the relationship between distance and coefficient of the coefficient table.

### DESCRIPTION OF EMBODIMENTS

In related art, each cell is connected with neighboring cells via connection lines. In a case where the distance between the cells is short, the communication time becomes short. However, in a case where the distance between the cells is long, the communication time becomes long. In a case where the communication time becomes long, the processing performance lowers.

According to an aspect of the present description, provided are technologies for being able to improve a communication speed between processing units.

With reference to the accompanying drawings, the following describes examples of an information processing device, an information processing method, and a non-transitory computer-readable storage medium. Note that the following embodiments do not limit the disclosed technique, and that the embodiments may be combined appropriately unless it causes inconsistency in the contents of processing.

### First Embodiment

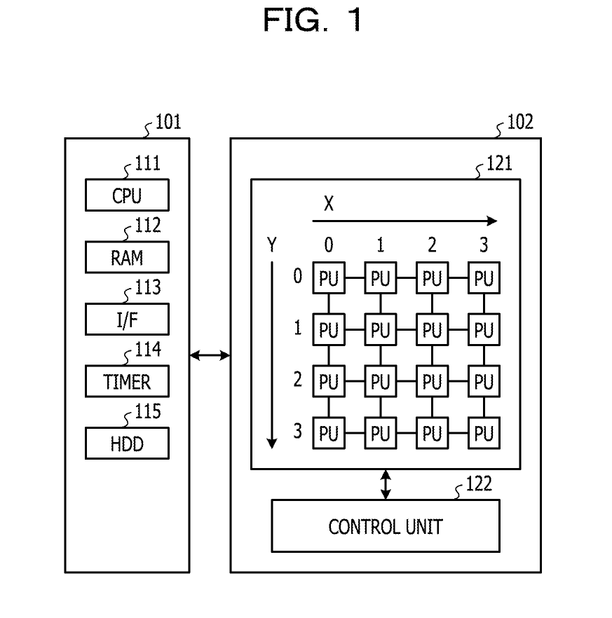

FIG. 1 is a diagram that illustrates a configuration example of an information processing system according to a first embodiment. The information processing system has an information processing device 101 and a reconfigurable circuit 102. The information processing device 101 is a computer and has a central processing unit (CPU) 111, a random access memory (RAM) 112, a communication interface 113, a timer 114, and a hard disk drive (HDD) unit 115. The CPU 111 reads out a program from the HDD unit 115, expands the program, which is read out, in the RAM 112, and executes the program, which is expanded in the RAM 112. The CPU 111 may acquire time information from the timer 114. Further, the CPU 111 may perform communication with the reconfigurable circuit 102 via the communication interface 113. The information processing device 101 may control the reconfigurable circuit 102.

The reconfigurable circuit 102 has a processing unit array 121 and a control unit 122. The processing unit array 121 is configured with a field programmable gate array (FPGA), for example, and has plural processing units PU that are aligned in a two-dimensional matrix. For example, the processing units PU are aligned in four rows and four columns. The processing unit PU is represented as PU(x,y) in a case where the X coordinate value is x and the Y coordinate value is y. The plural processing units PU are respectively connected with the neighboring processing units PU by communication paths. The control unit 122 writes FPGA configuration data that include communication path information in the processing unit array 121, which is the FPGA, and may thereby change the communication paths among the processing units PU.

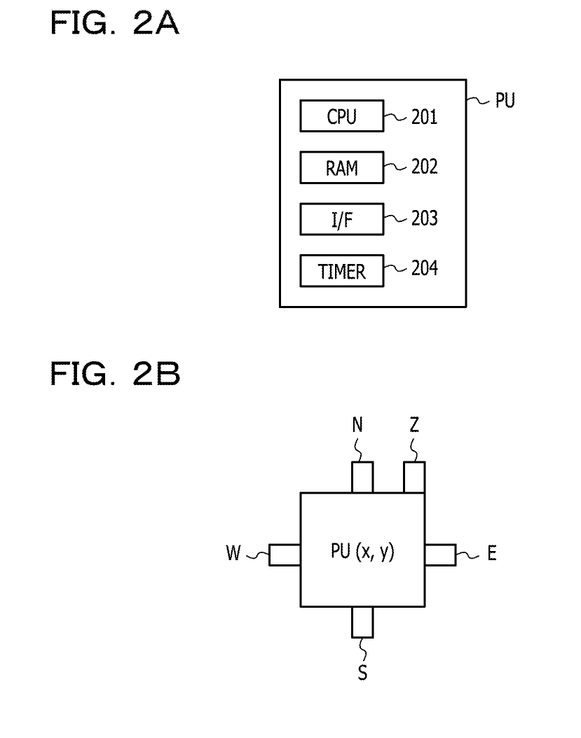

FIG. 2A is a diagram that illustrates a configuration example of each of the processing units PU. The processing unit PU has a CPU 201, a RAM 202, a communication interface 203, and a timer 204. The information processing device 101 may write a program and data in the RAM 202 via the control unit 122. The CPU 201 executes a program that is stored in the RAM 202. The CPU 201 may acquire time information from the timer 204. Further, the CPU 201 may perform communication with the other processing units PU via the communication interface 203. The processing unit PU may perform communication with the other processing unit PU via the communication path.

Note that similarly to the processing unit PU, the control unit 122 has the CPU 201, the RAM 202, the communication interface 203, and the timer 204.

FIG. 2B is a diagram that illustrates a configuration example of ports of each of the processing units. The processing unit PU(x,y) has a first port N, a second port E, a third port S, a fourth port W, and a bypass port Z. The first port N is a port for connecting with a processing unit PU(x,y−1) that neighbors the subject processing unit PU(x,y) on the upper side. The second port E is a port for connecting with a processing unit PU(x+1,y) that neighbors the subject processing unit PU(x,y) on the right side. The third port S is a port for connecting with a processing unit PU(x,y+1) that neighbors the subject processing unit PU(x,y) on the lower side. The fourth port W is a port for connecting with a processing unit PU(x−1,y) that neighbors the subject processing unit PU(x,y) on the left side.

The processing unit PU(x,y) is connected with the processing unit PU(x,y−1), which neighbors the processing unit PU(x,y) on the upper side, via the first port N. Further, the processing unit PU(x,y) is connected with the processing unit PU(x+1,y), which neighbors the processing unit PU(x,y) on the right side, via the second port E. Further, the processing unit PU(x,y) is connected with the processing unit PU(x,y+1), which neighbors the processing unit PU(x,y) on the lower side, via the third port S. Further, the processing unit PU(x,y) is connected with the processing unit PU(x−1,y), which neighbors the processing unit PU(x,y) on the left side, via the fourth port W.

The bypass port Z is an auxiliary port and is not connected with any processing unit PU in an initial state.

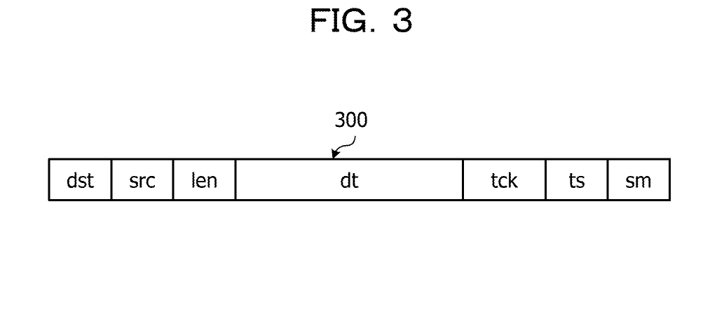

FIG. 3 is a diagram that illustrates an example of a packet 300 which is transmitted by the processing unit PU to the other processing unit PU. The packet 300 has transmission destination information dst, transmission source information src, a data length len, data dt, transit information tck, a timestamp ts, and a checksum sm.

The transmission destination information dst indicates a transmission destination processing unit PU of this packet 300. The transmission source information src indicates a transmission source processing unit PU of this packet 300. Each of the transmission destination information dst and the transmission source information src is 4 bits in a case where 16 processing units PU are present, for example. The packet 300 is transmitted from the processing unit PU indicated by the transmission source information src to the processing unit PU indicated by the transmission destination information dst. The data length len indicates the length of the data dt. The data dt are a data main body (payload). The data dt have a variable length, and the others have fixed lengths.

The transit information tck indicates the processing units PU, which this packet 300 transits, and is used for inhibiting the packet 300 from looping around a communication route. In a case where 16 processing units PU are present, the transit information is 16 bits, and the 16 bits respectively correspond to the 16 processing units PU. The time stamp ts indicates a transmission time. The checksum sm is error detection data for checking errors in the portion in the packet 300 except the transit information tck.

The processing unit PU that performs transmission performs an initial setting of the transit information tck to 0, generates the packet 300 that includes the transmission destination information dst, the transmission source information src, the data length len, the data dt, the transit information tck, the timestamp ts, and the checksum sm, and transmits the packet 300 to the processing unit PU indicated by the transmission destination information dst. In a case where the processing unit PU receives the packet 300, the processing unit PU sets the bit, which corresponds to the subject processing unit PU in the transit information tck in the packet 300, to 1 and transmits the packet 300 to the processing unit PU indicated by the transmission destination information dst. Further, in a case where the transmission destination information dst in the packet 300 is the subject processing unit PU, the processing unit PU acquires the data dt in the packet 300.

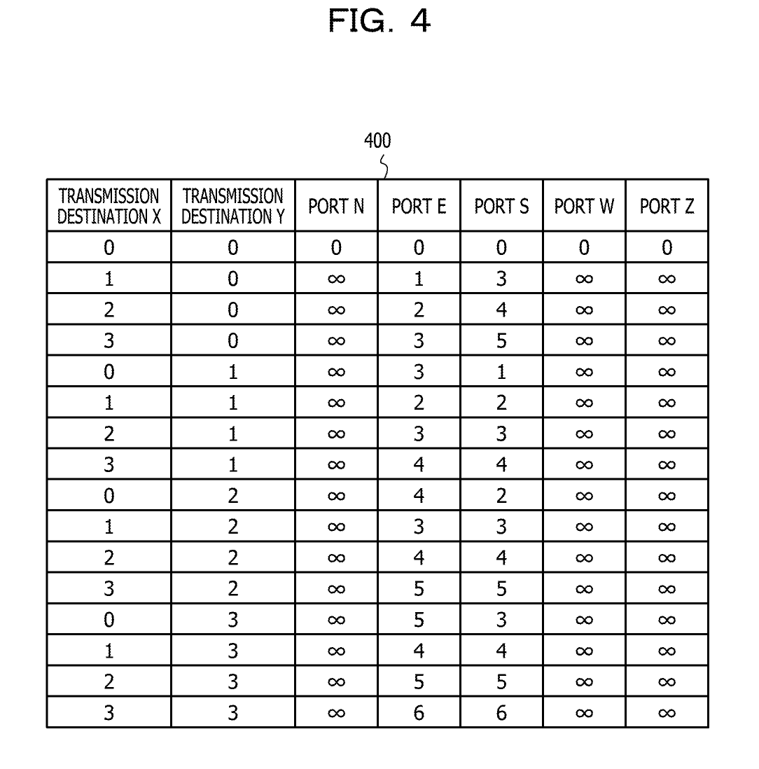

FIG. 4 is a diagram that illustrates examples of initial values of a routing table 400 of a processing unit PU(0,0). As illustrated in FIG. 1 and FIG. 2B, in the initial state, the bypass port Z of each of the processing units PU is not connected with any processing unit PU.

A description will be made about an example of the routing table 400 of the processing unit PU(0,0). However, the routing tables 400 of the other processing units PU are similar. The information processing device 101 generates the routing table 400 for each of the processing units PU and performs control such that the routing tables 400 of plural processing units PU are respectively written in the RAMs 202 of the plural processing units PU.

The routing table 400 has pieces of information of a transmission destination X, a transmission destination Y, the port N, the port E, the port S, the port W, and the port Z. The transmission destination X indicates the X coordinate value of the transmission destination processing unit PU. The transmission destination Y indicates the Y coordinate value of the transmission destination processing unit PU. The port N indicates the shortest distance (Manhattan distance) from the subject processing unit PU(0,0) to the transmission destination processing unit PU in a case where the port N is used. The port E indicates the shortest distance (Manhattan distance) from the subject processing unit PU(0,0) to the transmission destination processing unit PU in a case where the port E is used. The port S indicates the shortest distance (Manhattan distance) from the subject processing unit PU(0,0) to the transmission destination processing unit PU in a case where the port S is used. The port W indicates the shortest distance (Manhattan distance) from the subject processing unit PU(0,0) to the transmission destination processing unit PU in a case where the port W is used. The port Z indicates the shortest distance (Manhattan distance) from the subject processing unit PU(0,0) to the transmission destination processing unit PU in a case where the port Z is used.

The Manhattan distance is the distance between the transmission source processing unit PU and the transmission destination processing unit PU and is the sum of the absolute values of the differences between the coordinate values of the transmission source processing unit PU and the coordinate values of the transmission destination processing unit PU.

The first row of the routing table 400 indicates the shortest distance from the subject processing unit PU(0,0) to the transmission destination processing unit PU(0,0), and the shortest distances for all the ports are 0.

The second row of the routing table 400 indicates the shortest distance from the subject processing unit PU(0,0) to a transmission destination processing unit PU(1,0). The shortest distance for the port E is 1, the shortest distance for the port S is 3, and the shortest distance for the ports N, W, and Z is ∞.

The eleventh row of the routing table 400 indicates the shortest distance from the subject processing unit PU(0,0) to a transmission destination processing unit PU(2,2). The shortest distance for the ports E and S is 4, and the shortest distance for the ports N, W, and Z is ∞.

As illustrated in FIG. 1 and FIG. 2B, because the ports N, W, and Z of the processing unit PU(0,0) are not connected with any processing unit PU and transmission by using the port N, W, or Z is not possible, the shortest distance of the ports N, W, and Z with respect to all the transmission destinations is expressed as ∞.

Further, because the ports Z of none of the processing units PU are connected with any processing unit PU in the initial state and transmission by using the port Z is not possible, the shortest distance of the port Z with respect to all the transmission destinations is expressed as ∞.

As described above, in accordance with the communication path that connects plural processing units PU, the information processing device 101 generates the routing table 400, which indicates the distance from the subject processing unit PU to the other processing unit PU, with respect to each of the processing units PU.

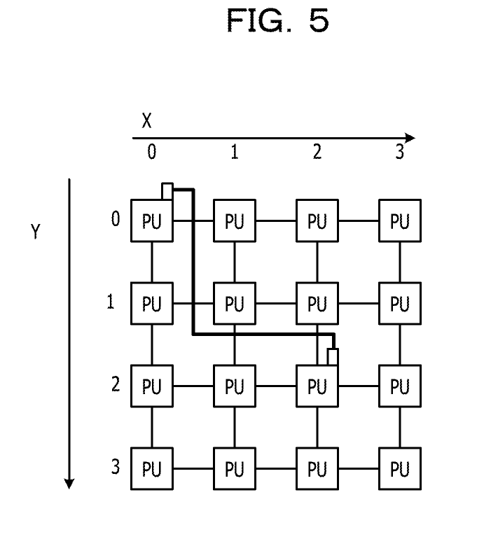

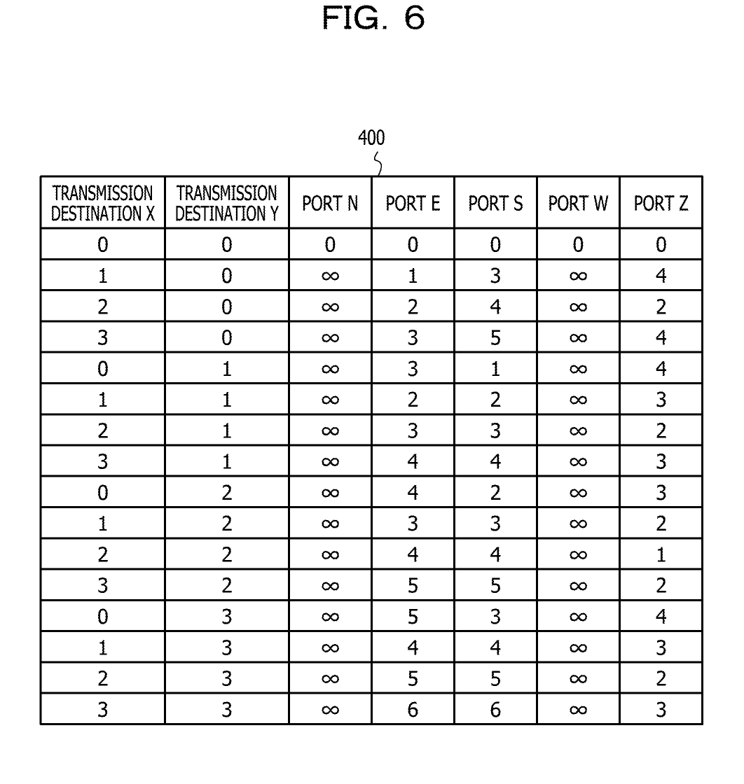

FIG. 5 is a diagram that illustrates an example where a bypass communication path is connected between the bypass port Z of the processing unit PU(0,0) and the bypass port Z of the processing unit PU(2,2). In a case where the information processing device 101 instructs the control unit 122 to add the above bypass communication path, the control unit 122 writes the FPGA configuration data that reflect bypass communication path information in the processing unit array 121, and the bypass communication path is thereby configured between the bypass port Z of the processing units PU(0,0) and the bypass port Z of the processing unit PU(2,2). In this case, the processing unit PU(0,0) may transmit the packet 300 to the processing unit PU(2,2) at a high speed by using the bypass communication path of the bypass ports Z. Further, the information processing device 101 updates the routing table 400 of FIG. 4 to the routing table 400 of FIG. 6 in which the bypass communication path is added and respectively supplies the updated routing tables 400 of plural processing units PU to the RAMs 202 of the plural processing units PU.

FIG. 6 is a diagram that illustrates an example of the routing table 400 of the processing unit PU(0,0) in a case where the bypass communication path in FIG. 5 is added. A description will be made about different points of the routing table 400 of FIG. 6 from the routing table 400 of FIG. 4. In the state of FIG. 5, the bypass port Z of the processing unit PU(0,0) is connected with the bypass port Z of the processing unit PU(2,2). Consequently, the column of the port Z in the routing table 400 is updated.

In the routing table 400 of FIG. 4, the shortest distance from the subject processing unit PU(0,0) to the transmission destination processing unit PU(2,2) is 4. However, in the routing table 400 of FIG. 6, the bypass communication path is connected with the bypass ports Z, and the shortest distance from the subject processing unit PU(0,0) to the transmission destination processing unit PU(2,2) thereby becomes 1. The bypass communication path is provided, and the shortest distance (communication time) from the subject processing unit PU(0,0) to the transmission destination processing unit PU(2,2) thereby becomes shorter.

Next, a description will be made about a method in which the information processing device 101 generates the routing table 400. First, the information processing device 101 acquires shortest distances Dist((x0,y0),(x1,y1)) among all the processing units PU. The shortest distance Dist((x0,y0),(x1,y1)) is the shortest distance from a processing unit PU(x0,y0) to a processing unit PU(x1,y1) and is the number of communication paths that the packet 300 transits from the processing unit PU(x0,y0) to the processing unit PU(x1,y1).

In the first step, in a case where with respect to all the combinations of the processing unit PU(x,y) and a processing unit PU(x2,y2), it is possible for the packet 300 to reach the processing unit PU(x2,y2) from the processing unit PU(x,y) by a distance of 1 by transiting the ports, the information processing device 101 sets Dist((x,y),(x2,y2))=1. Otherwise, the information processing device 101 sets Dist((x,y),(x2,y2))=∞.

In the second step, in a case where with respect to all the combinations of the processing unit PU(x0,y0) and the processing unit PU(x1,y1), the processing unit PU(x,y) for which formula (1) holds true is present, the information processing device 101 updates the shortest distance Dist as formula (2).

Dist((x0,y0),(x,y))+Dist((x,y),(x1,y1))<Dist((x0,y0),(x1,y1)) . . . (1)

Dist((x0,y0),(x1,y1))=Dist((x0,y0),(x,y))+Dist((x,y),(x1,y1)) . . . (2)

The information processing device 101 repeats the second step as long as the above update is possible. Then, when the second step finishes, the information processing device 101 may obtain the shortest distances Dist among all the processing units PU.

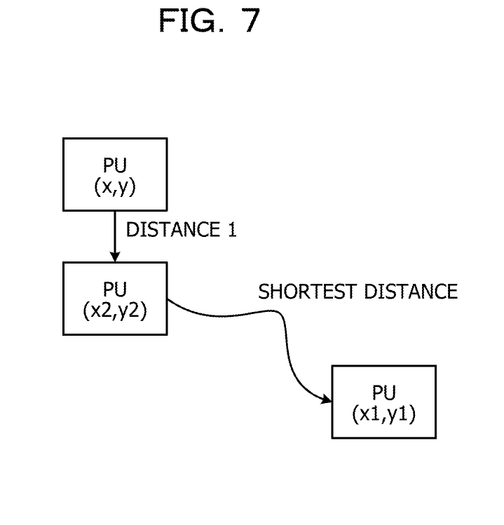

FIG. 7 is a diagram for explaining the method in which the information processing device 101 generates the routing table 400. A distance RT(x,y)(x1,y1)(pt) corresponds to the shortest distance for each of the ports in the routing table 400 and indicates the shortest distance in a case where transmission is performed from the processing unit PU(x,y) to the transmission destination processing unit PU(x1,y1) via each port pt.

The information processing device 101 may execute a function Go((x,y),pt) of a program. The function Go((x,y),pt) is a function that returns the coordinate values of a connection destination processing unit PU of the port pt of the processing unit PU. For example, as illustrated in FIG. 2B, in a case of the processing unit PU(x,y), the information processing device 101 executes the function Go((x,y),pt) and may thereby obtain the coordinate values of the connection destination processing units PU, which are expressed by the following formulas.

Go((x,y),N)=(x,y−1)

Go((x,y),E)=(x+1,y)

Go((x,y),W)=(x−1,y)

Go((x,y),S)=(x,y+1)

Further, in a case where the port pt of the processing unit PU(x,y) is not connected, the function Go((x,y),pt) is expressed as the following formula.

Go((x,y),pt)=(∞,∞)

For example, in a case of the processing unit PU(0,0) in FIG. 1, the function Go((x,y),pt) is expressed as the following formulas.

Go((0,0),N)=(∞,∞)

Go((0,0),E)=(1,0)

Go((0,0),W)=(∞,∞)

Go((0,0),S)=(0,1)

Go((0,0),Z)=(∞,∞)

Further, in a case of the processing unit PU(0,0) in FIG. 5, the function Go((x,y),pt) is expressed as the following formulas.

Go((0,0),N)=(∞,∞)

Go((0,0),E)=(1,0)

Go((0,0),W)=(∞,∞)

Go((0,0),S)=(0,1)

Go((0,0),Z)=(2,2)

As illustrated in FIG. 7, in a case where the connection destination of the port pt of the processing unit PU(x,y) is the processing unit PU(x2,y2), the function Go((x,y),pt) is expressed as the following formula.

Go((x,y),pt)=(x2,y2)

In this case, the shortest distance from the processing unit PU(x,y) to the processing unit PU(x2,y2) via the port pt is 1. The information processing device 101 may obtain a routing table RT(x,y)(x1,y1)(pt) as the following formula.

RT(x,y)(x1,y1)(pt)=1+Dist((x2,y2),(x1,y1))

Here, as in FIG. 7, the shortest distance Dist((x2,y2),(x1,y1)) is the shortest distance from the processing unit PU(x2,y2) to the processing unit PU(x1,y1). In such a manner, the information processing device 101 may generate the routing tables 400 of FIG. 4 and FIG. 6.

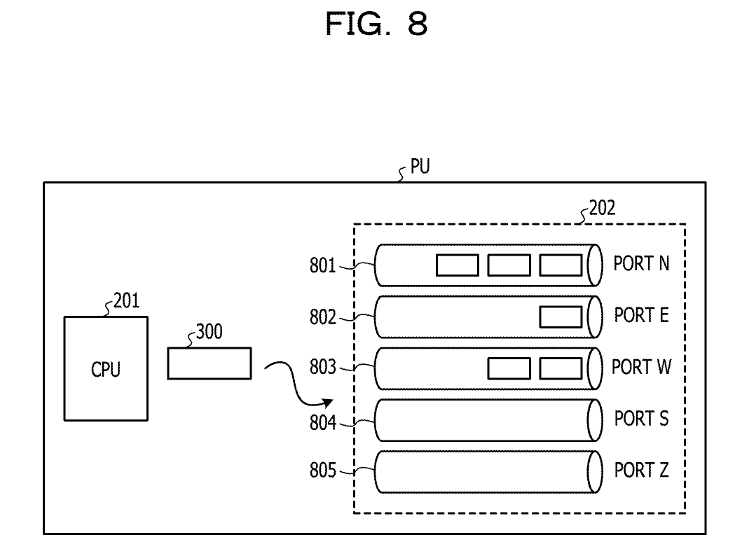

FIG. 8 is a diagram for explaining a method in which the processing unit PU decides the port (route) for transmission (communication). The processing unit PU has the CPU 201 and the RAM 202. The RAM 202 has transmission queues 801 to 805. The transmission queue 801 stores the packet 300 that is transmitted by the processing unit PU from the port N in a first-in first-out manner. The transmission queue 802 stores the packet 300 that is transmitted by the processing unit PU from the port E in the first-in first-out manner. The transmission queue 803 stores the packet 300 that is transmitted by the processing unit PU from the port W in the first-in first-out manner. The transmission queue 804 stores the packet 300 that is transmitted by the processing unit PU from the port S in the first-in first-out manner. The transmission queue 805 stores the packet 300 that is transmitted by the processing unit PU from the port Z in the first-in first-out manner.

Next, a description will be made about a method in which the processing unit PU decides to transmit the packet 300 from which of the ports N, E, W, S, and Z. The port pt is any one port of the ports N, E, W, S, and Z. A communication rate RA indicates the communication rate [bytes/second] of the packet 300.

A packet length L1 is the length of the packet 300. In FIG. 3, as for the packet 300, the data dt have a variable length, the portions other than the data dt have fixed lengths. Consequently, the CPU 201 may calculate the packet length L1 based on the data length len in the packet 300. A queue length L2(pt) indicates the total length of the packets 300, which are stored in the transmission queues 801 to 805 of the port pt and are waiting for transmission.

As expressed by formula (3), the CPU 201 calculates waiting times T1(pt) of all the ports pt by using the distance RT of the routing table 400. Here, the first term of formula (3) is the communication time of the packet 300 that is stored in the transmission queue and waiting for transmission. The second term of formula (3) is the communication time of the packet 300 as a transmission target.

T1(pt)=L2(pt)/RA+L1/RA×(RT(x,y)(x1,y1)(pt)) . . . (3)

Next, the CPU 201 selects the port pt in which the waiting time T1(pt) becomes shortest and stores the packet 300 as the transmission target in the transmission queue of the selected port pt among the transmission queues 801 to 805.

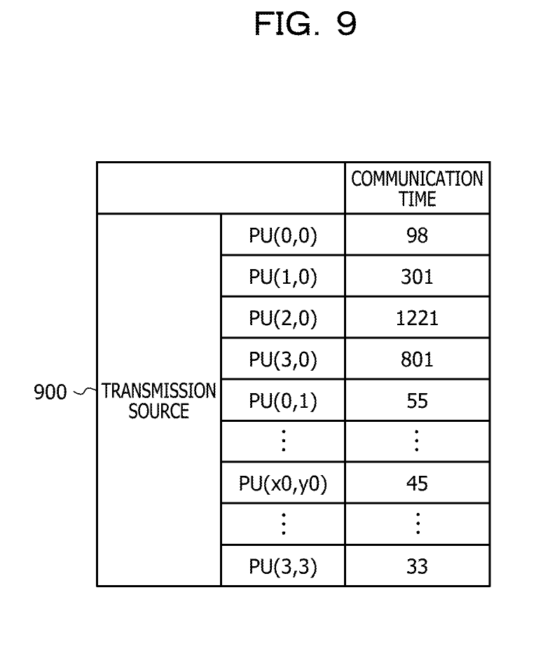

FIG. 9 is a diagram that illustrates an example of a communication time table 900 which is generated by the transmission destination processing unit PU(x1,y1). Every processing unit PU generates the communication time table 900 in which the communication times of the packets 300 in a case where the subject processing unit PU is the transmission destination processing unit PU are accumulated with respect to each of the transmission source processing units PU.

Specifically, every processing unit PU resets the communication times in the communication time table 900 to 0 in the initial state. Then, in a case where each of the processing units PU receives the packet 300 and the transmission destination information dst in the packet 300 is the subject processing unit PU, the processing unit PU performs a reception completion process of the packet 300 and acquires the reception time from the timer 204. Then, each of the processing units PU performs the reception completion process, thereafter subtracts the timestamp (transmission time) ts of the packet 300 from the above reception time, and thereby obtains the communication time of the packet 300. Then, each of the processing units PU adds the communication time of the packet 300 to the communication time of the transmission source processing unit PU, which is indicated by the transmission source information src of the packet 300 in the communication time table 900. Accordingly, each of the processing units PU may store the cumulative value of the communication times of the packets 300, for which the subject processing unit PU is the transmission destination information dst, as the communication time of each of the transmission source processing units PU, which is indicated by the transmission source information src in the communication time table 900. The communication time table 900 indicates the communication times from all the transmission source processing units PU to the subject processing unit PU.

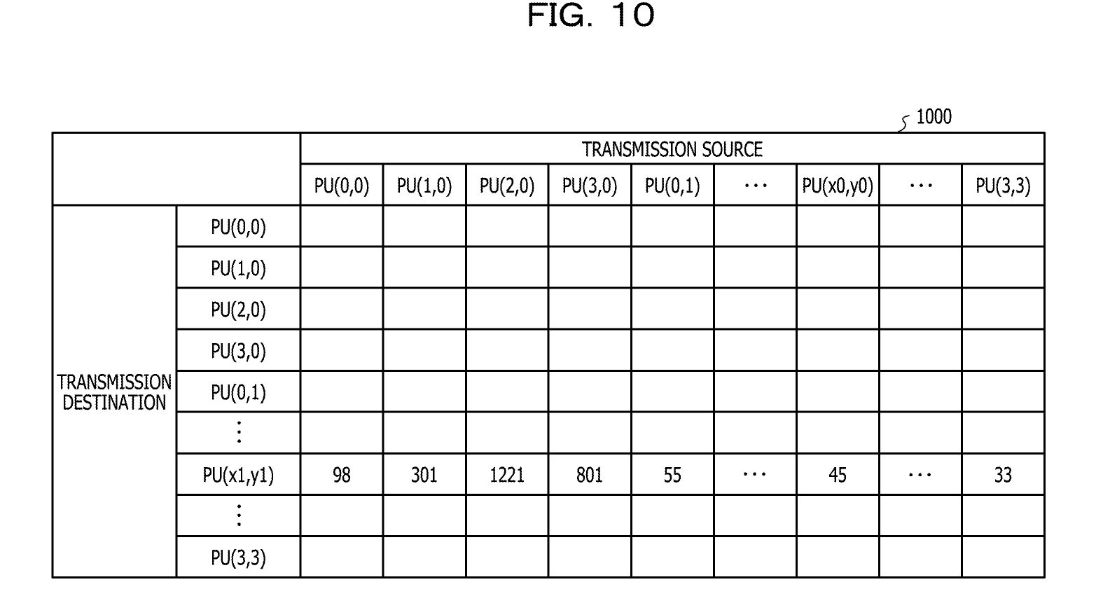

FIG. 10 is a diagram that illustrates an example of a communication time table 1000 which is generated by the information processing device 101. The information processing device 101 acquires the communication time tables 900 of all the processing units PU at each specific time TA and generates the communication time table 1000. Specifically, the information processing device 101 stores the communication time tables 900 of the respective processing units PU as the communication times of the transmission source processing units PU of the respective rows of the communication time table 1000. For example, the information processing device 101 stores the communication time table 900 of the processing unit PU(x1,y1) as the communication times of the row of the transmission source processing unit PU(x1,y1) of the communication time table 1000. The communication time table 1000 indicates the communication times between all the transmission source processing units PU and transmission destination processing units PU.

First, a description will be made about an addition method of the bypass communication path. The information processing device 101 acquires a maximum communication time TT((xs,ys),(xd,yd)) among the communication times (communication costs) in the communication time table 1000. The communication time TT((xs,ys),(xd,yd)) indicates the communication time from a transmission source processing unit PU(xs,ys) to a transmission destination processing unit PU(xd,yd). In a case where the maximum communication time TT((xs,ys),(xd,yd)) is longer than a first threshold value, the information processing device 101 controls the reconfigurable circuit 102 so as to add the bypass communication path for connecting the bypass port Z of the transmission source processing unit PU(xs,ys) and the bypass port Z of the transmission destination processing unit PU(xd,yd) as illustrated in FIG. 5. Accordingly, the communication time between the transmission source processing unit PU(xs,ys) and the transmission destination processing unit PU(xd,yd) may be shortened.

Next, a description will be made about a deletion method of the bypass communication path. In a case where the use frequency of the bypass communication path is low after the bypass communication path is added, the information processing device 101 may delete the bypass communication path. Specifically, in a case where the bypass communication path is added between the transmission source processing unit PU(xs,ys) and the transmission destination processing unit PU(xd,yd), the information processing device 101 refers to the communication time table 1000. In a case where the communication time TT((xs,ys),(xd,yd)) between the transmission source processing unit PU(xs,ys) and the transmission destination processing unit PU(xd,yd) is shorter than a second threshold value, the information processing device 101 controls the reconfigurable circuit 102 so as to delete the bypass communication path that connects the bypass port Z of the transmission source processing unit PU(xs,ys) and the bypass port Z of the transmission destination processing unit PU(xd,yd). Accordingly, the undesired bypass communication path between the transmission source processing unit PU(xs,ys) and the transmission destination processing unit PU(xd,yd) may be deleted.

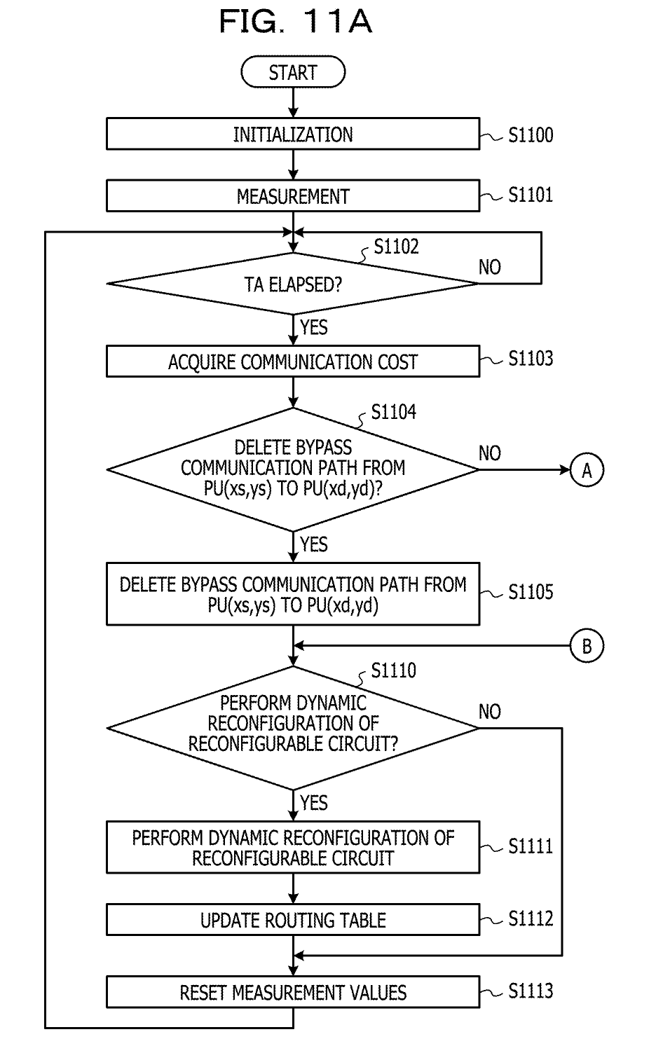

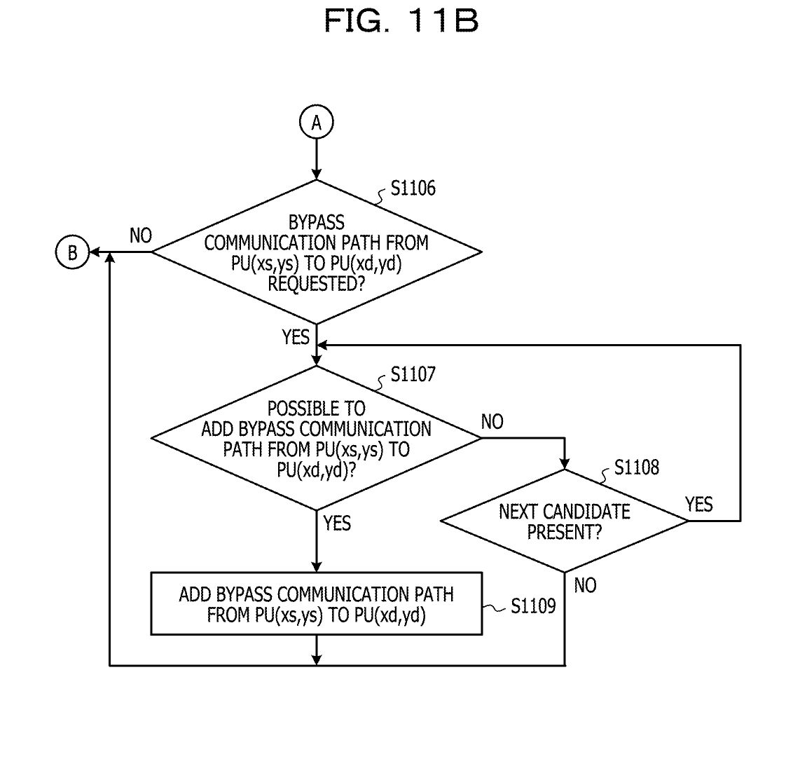

FIG. 11 (i.e. FIGS. 11A and 11B) is a flowchart that illustrates an information processing method of the information processing device 101. In the information processing device 101, the CPU 111 executes a program in the RAM 112 and may thereby perform a process of FIG. 11.

In step S1100, the CPU 111 performs an initialization process. Specifically, as illustrated in FIG. 4, the CPU 111 generates the respective routing tables 400 of the processing units PU of the reconfigurable circuit 102 that has no bypass communication path and performs control for writing the routing tables 400 in the RAMs 202 of the respective processing units PU. Then, the CPU 111 performs control for resetting all the communication time tables 900 in the RAMs 202 of the respective processing units PU to 0. Accordingly, the control unit 122 writes the routing tables 400 in the RAMs 202 of the respective processing units PU and resets all the communication time tables 900 in the RAMs 202 of the respective processing units PU to 0. Further, the CPU 111 resets a processing timer value to 0. The timer 114 starts counting-up of the processing timer value.

Next, in step S1101, the CPU 111 outputs a processing start instruction that includes the FPGA configuration data of circuit information (including the communication path information) and data to the reconfigurable circuit 102. The control unit 122 writes the FPGA configuration data in the processing unit array 121. As illustrated in FIG. 1, the communication paths in the initial state where no bypass communication path is present are formed in the processing unit array 121. Each of the processing units PU starts data processing and communication.

Further, the CPU 111 controls each of the processing units PU such that each of the processing units PU starts measurement of the communication time and update of the communication time table 900. Each of the processing units PU starts the measurement of the communication time and the update of the communication time table 900.

Next, in step S1102, the CPU 111 stands by until the specific time TA elapses on the processing timer value and moves the process to step S1103 in a case where the specific time TA has elapsed.

In step S1103, the CPU 111 acquires the communication time (communication cost) tables 900 of the respective processing units PU, generates the communication time table 1000, and writes the communication time table 1000 in the RAM 112.

Next, in step S1104, in a case where the bypass communication path is present in the processing unit array 121, the CPU 111 assesses whether or not the bypass communication path has to be deleted. In the initial state, the CPU 111 assesses that no bypass communication path is present and moves the process to step S1106.

In step S1106, the CPU 111 acquires the maximum communication time TT((xs,ys),(xd,yd)) among the communication times (communication costs) in the communication time table 1000. Next, the CPU 111 assesses whether or not the maximum communication time TT((xs,ys),(xd,yd)) is longer than the first threshold value and moves the process to step S1107 in a case where the maximum communication time TT((xs,ys),(xd,yd)) is longer than the first threshold value but moves to step S1110 in a case where the maximum communication time TT((xs,ys),(xd,yd)) is shorter than the first threshold value.

In step S1107, the CPU 111 assesses whether or not it is possible to add the bypass communication path between the bypass port Z of the transmission source processing unit PU(xs,ys) and the bypass port Z of the transmission destination processing unit PU(xd,yd), which correspond to the maximum communication time TT((xs,ys),(xd,yd)). For example, in a case where the bypass port Z of the transmission source processing unit PU(xs,ys) or the transmission destination processing unit PU(xd,yd) are already used, the CPU 111 assesses that it is not possible to add the bypass communication path between the bypass port Z of the transmission source processing unit PU(xs,ys) and the bypass port Z of the transmission destination processing unit PU(xd,yd). Further, in a case where the bypass ports Z of the transmission source processing unit PU(xs,ys) and the transmission destination processing unit PU(xd,yd) are not yet used and a sufficient circuit resource for wiring of the bypass communication path is present in the FPGA, the CPU 111 assesses that it is possible to add the bypass communication path between the bypass port Z of the transmission source processing unit PU(xs,ys) and the bypass port Z of the transmission destination processing unit PU(xd,yd). Note that the number of bypass ports Z of each of the processing units PU is not limited to one but may be two or more. The CPU 111 moves the process to step S1109 in a case where the CPU 111 assesses that it is possible to add bypass communication path but moves to step S1108 in a case where the CPU 111 assesses that it is not possible to add bypass communication path.

In step S1108, the CPU 111 assesses whether or not a next candidate for the bypass communication path is present. Specifically, the CPU 111 acquires the second longest communication time TT((xs,ys),(xd,yd)) among the communication times in the communication time table 1000 as the next candidate. Next, the CPU 111 assesses whether or not the second longest communication time TT((xs,ys),(xd,yd)) is longer than the first threshold value and returns the process to step S1107 in a case where the second longest communication time TT((xs,ys),(xd,yd)) is longer than the first threshold value but moves to step S1110 in a case where the second longest communication time TT((xs,ys),(xd,yd)) is shorter than the first threshold value. In step S1107, the CPU 111 assesses whether or not it is possible to add the bypass communication path to the next candidate. Note that in step S1108, the CPU 111 sets the next longest communication time to the processing target of step S1107 as the next candidate.

In step S1109, the CPU 111 generates the FPGA configuration data of the communication path information for adding the bypass communication path between the bypass port Z of the transmission source processing unit PU(xs,ys) and the bypass port Z of the transmission destination processing unit PU(xd,yd) and moves the process to step S1110.

In step S1110, the CPU 111 assesses whether or not dynamic reconfiguration is performed for the reconfigurable circuit 102. Specifically, the CPU 111 assesses that the dynamic reconfiguration is performed in a case where the FPGA configuration data for adding the bypass communication path is generated in step S1109 but assesses that the dynamic reconfiguration is not performed in a case where the FPGA configuration data for adding the bypass communication path is not generated. The CPU 111 moves the process to step S1111 in a case where the CPU 111 assesses that the dynamic reconfiguration is performed but moves to step S1113 in a case where the CPU 111 assesses that the dynamic reconfiguration is not performed.

In step S1111, the CPU 111 outputs the FPGA configuration data for adding the bypass communication path to the reconfigurable circuit 102. Then, the control unit 122 writes the FPGA configuration data in the processing unit array 121. Accordingly, in the processing unit array 121, the bypass communication path is added between the bypass port Z of the transmission source processing unit PU(xs,ys) and the bypass port Z of the transmission destination processing unit PU(xd,yd).

Next, in step S1112, the CPU 111 updates the routing tables 400 of the respective processing units PU as illustrated in FIG. 6 in accordance with the addition of the above bypass communication path. Then, the CPU 111 performs control such that the routing tables 400 are written in the RAMs 202 of the respective processing units PU. The control unit 122 performs control such that the routing tables 400 are written in the RAMs 202 of the respective processing units PU. Subsequently, the CPU 111 moves the process to step S1113.

In step S1113, the CPU 111 controls the reconfigurable circuit 102 such that all the communication times of the communication time table 900 of each of the processing units PU are reset to 0. The control unit 122 resets all the communication times of the communication time table 900 in the RAM 202 of each of the processing units PU to 0. Further, the CPU 111 resets the processing timer value to 0 and returns the process to step S1102.

In step S1102, the CPU 111 stands by until the specific time TA elapses on the processing timer value and moves the process to step S1103 in a case where the specific time TA has elapsed. In step S1103, the CPU 111 acquires the communication time tables 900 of the respective processing units PU, generates the communication time table 1000, and writes the communication time table 1000 in the RAM 112.

Next, in step S1104, the CPU 111 assesses whether or not the bypass communication path is present in the processing unit array 121. In a case where the bypass communication path is present, the CPU 111 assesses whether or not the bypass communication path is deleted. Specifically, in a case where the bypass communication path is added between the transmission source processing unit PU(xs,ys) and the transmission destination processing unit PU(xd,yd), the CPU 111 refers to the communication time table 1000 and assesses whether or not the communication time TT((xs,ys),(xd,yd)) between the transmission source processing unit PU(xs,ys) and the transmission destination processing unit PU(xd,yd) is shorter than the second threshold value. Then, the CPU 111 moves the process to step S1105 in a case where the CPU 111 assesses that the communication time TT((xs,ys),(xd,yd)) is shorter than the second threshold value but moves the process to step S1106 in a case where the CPU 111 assesses that the communication time TT((xs,ys),(xd,yd)) is longer than the second threshold value. Processes of step S1106 and subsequent steps are similar to the above.

In step S1105, the CPU 111 generates the FPGA configuration data, in which the bypass communication path between the bypass port Z of the transmission source processing unit PU(xs,ys) and the bypass port Z of the transmission destination processing unit PU(xd,yd) is deleted, and moves the process to step S1110.

In step S1110, the CPU 111 assesses that the dynamic reconfiguration is performed in a case where the FPGA configuration data, in which the bypass communication path is deleted, are generated in step S1105 but assesses that the dynamic reconfiguration is not performed in a case where the FPGA configuration data, in which the bypass communication path is deleted, are not generated. The CPU 111 moves the process to step S1111 in a case where the CPU 111 assesses that the dynamic reconfiguration is performed but moves the process to step S1113 in a case where the CPU 111 assesses that the dynamic reconfiguration is not performed.

In step S1111, the CPU 111 outputs the FPGA configuration data, in which the bypass communication path is deleted, to the reconfigurable circuit 102. Then, the control unit 122 writes the FPGA configuration data in the processing unit array 121. Accordingly, in the processing unit array 121, the bypass communication path between the bypass port Z of the transmission source processing unit PU(xs,ys) and the bypass port Z of the transmission destination processing unit PU(xd,yd) is deleted.

Next, in step S1112, the CPU 111 updates the routing tables 400 of the respective processing units PU as illustrated in FIG. 4 in accordance with the deletion of the above bypass communication path. Then, the CPU 111 performs control such that the routing tables 400 are written in the RAMs 202 of the respective processing units PU. The control unit 122 performs control such that the routing tables 400 are written in the RAMs 202 of the respective processing units PU. Subsequently, the CPU 111 moves the process to step S1113. Processes of step S1113 and subsequent steps are similar to the above.

In this embodiment, the information processing device 101 may add the bypass communication path in a case where the communication time is longer than the first threshold value. Accordingly, the communication speed among the processing units PU may be improved. Further, the information processing device 101 may delete the bypass communication path in a case where the communication time of the bypass communication path is shorter than the second threshold value. Accordingly, an undesired bypass communication path may be deleted.

The communication time among the processing units PU changes in accordance with the processing contents of the processing units PU or the input data to the processing units PU. Thus, the route in which the bypass communication path has to be connected is not fixed. The reconfigurable circuit 102 measures the communication time during an action, and the information processing device 101 may thereby change the appropriate position of the bypass communication path.

Further, a method is possible in which many communication paths are initially provided among all the processing units PU. However, in this case, because wiring that is requested for the many communication paths increases, the area of the reconfigurable circuit 102 becomes large. If the semiconductor chip area may not be increased, the number of processing units PU decreases. In this embodiment, only the bypass communication path is directly connected between the bypass ports Z of the respective processing units PU. Thus, the number of pieces of wiring of the communication paths may be kept low, the increase in the area of the reconfigurable circuit 102 may be lowered, and the decrease in the number of configurable processing units PU may be lowered.

### Second Embodiment

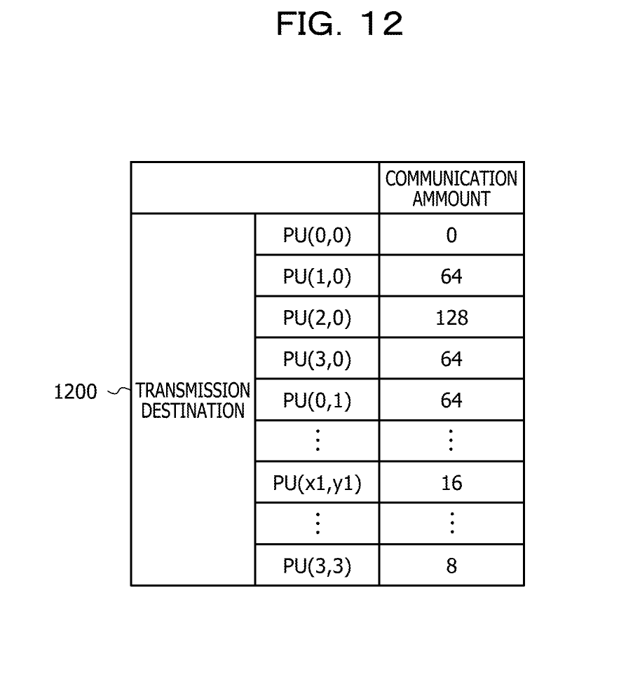

FIG. 12 is a diagram that illustrates an example of a communication amount table 1200 which is generated by each of the processing units PU(x0,y0) according to a second embodiment. Each of the processing units PU generates the communication amount table 1200 instead of the communication time table 900 of FIG. 9. In the following, a description will be made about different points of this embodiment from the first embodiment.

Every processing unit PU generates the communication amount table 1200 in which the communication amounts of the packets 300 are accumulated with respect to each of the transmission destination processing units PU. Specifically, every processing unit PU resets the communication amounts in the communication amount table 1200 to 0 in the initial state. Then, in a case where each of the processing units PU transmits the packet 300 and the subject processing unit PU is the transmission source processing unit PU or a relay processing unit PU, each of the processing units PU adds the packet length L1 of the packet 300 to the communication amount of the transmission destination processing unit PU, which is indicated by the transmission destination information dst of the packet 300 in the communication amount table 1200. Accordingly, each of the processing units PU may store the cumulative value of the communication amounts of the packets 300, which are transmitted by the subject processing unit PU, as the communication amount of each of the transmission destination processing units PU, which is indicated by the transmission destination information dst in the communication amount table 1200. The communication amount table 1200 indicates the communication amounts from the subject processing unit PU to all the transmission destination processing units PU.

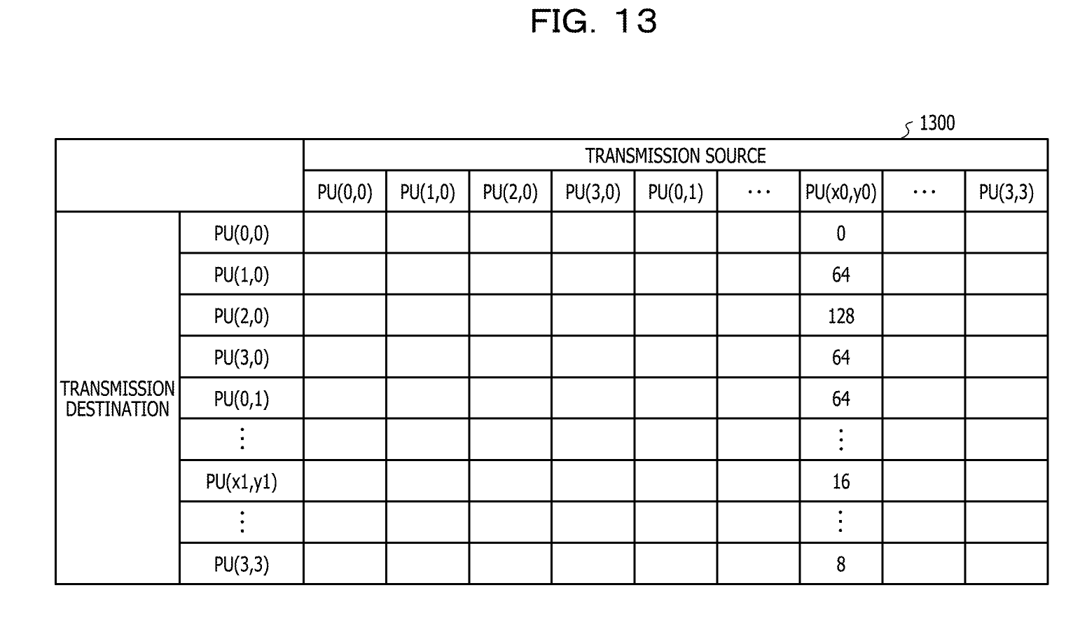

FIG. 13 is a diagram that illustrates an example of a communication amount table 1300 which is generated by the information processing device 101. The information processing device 101 acquires the communication amount tables 1200 of all the processing units PU at each specific time TA and generates the communication amount table 1300. Specifically, the information processing device 101 stores the communication amount tables 1200 of the respective processing units PU as the communication amounts of the transmission source processing units PU of the respective columns of the communication amount table 1300. For example, the information processing device 101 stores the communication amount table 1200 of the processing unit PU(x0,y0) as the communication amounts of the column of the transmission source processing unit PU(x0,y0) of the communication amount table 1300. The communication amount table 1300 indicates the communication amounts between all the transmission source processing units PU and transmission destination processing units PU.

Note that the communication amounts of the communication amount table 1300 do not include distance information between the processing units PU. However, it is preferable that the information processing device 101 adds the bypass communication path between the processing units PU at a long distance and thereby shortens the communication time between the processing units PU. In the following, a description will be made about a method of correcting the communication amount by the distance information.

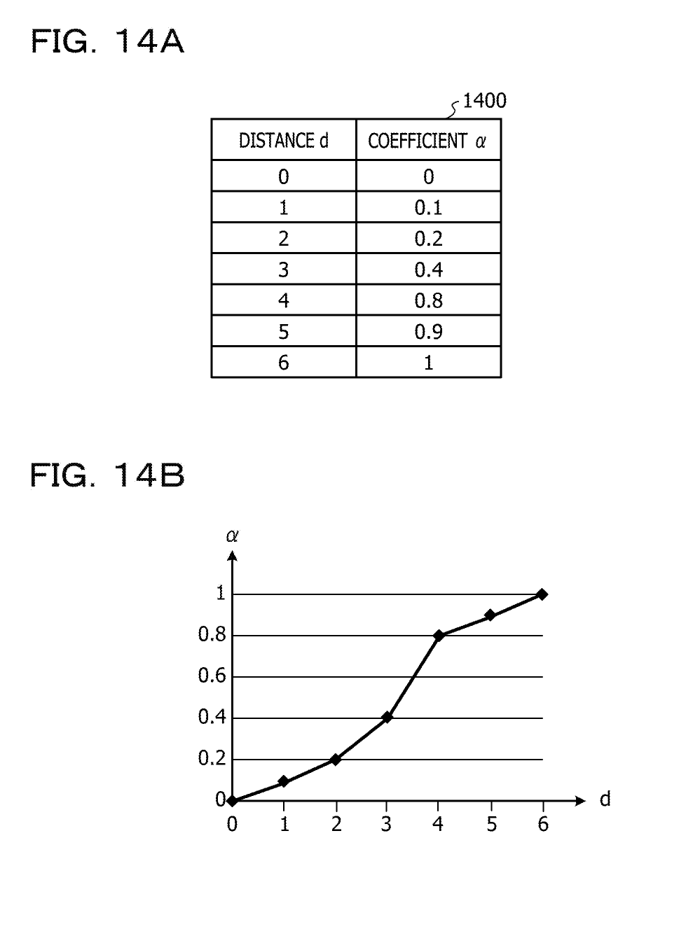

FIG. 14A is a diagram that illustrates an example of a coefficient table 1400, and FIG. 14B is a graph that represents the relationship between distance d and coefficient α of the coefficient table 1400. The RAM 112 of the information processing device 101 stores the coefficient table 1400. The coefficient table 1400 indicates the relationship between the distance d between the transmission source processing unit PU and the transmission destination processing unit PU and the coefficient α. The distance d is the same as the above shortest distance Dist. The coefficient α becomes larger as the distance d becomes longer. The information processing device 101 multiplies each of the communication amounts of the communication amount table 1300 of FIG. 13 by the coefficient α in accordance with the distance d indicated by the coefficient table 1400 and corrects each of the communication amounts of the communication amount table 1300.

First, a description will be made about an addition method of the bypass communication path. The information processing device 101 acquires a maximum communication amount DD((xs,ys),(xd,yd)) among the communication amounts (communication costs) in the communication amount table 1300. The communication amount DD((xs,ys),(xd,yd)) indicates the communication amount from the transmission source processing unit PU(xs,ys) to the transmission destination processing unit PU(xd,yd). In a case where the maximum communication amount DD((xs,ys),(xd,yd)) is larger than a first threshold value, the information processing device 101 controls the reconfigurable circuit 102 so as to add the bypass communication path for connecting the bypass port Z of the transmission source processing unit PU(xs,ys) and the bypass port Z of the transmission destination processing unit PU(xd,yd) as illustrated in FIG. 5. Accordingly, the communication time between the transmission source processing unit PU(xs,ys) and the transmission destination processing unit PU(xd,yd) may be shortened.

Next, a description will be made about a deletion method of the bypass communication path. In a case where the use frequency of the bypass communication path is low after the bypass communication path is added, the information processing device 101 may delete the bypass communication path. Specifically, in a case where the bypass communication path is added between the transmission source processing unit PU(xs,ys) and the transmission destination processing unit PU(xd,yd), the information processing device 101 refers to the communication amount table 1300. In a case where the communication amount DD((xs,ys),(xd,yd)) between the transmission source processing unit PU(xs,ys) and the transmission destination processing unit PU(xd,yd) is smaller than a second threshold value, the information processing device 101 controls the reconfigurable circuit 102 so as to delete the bypass communication path that connects the bypass port Z of the transmission source processing unit PU(xs,ys) and the bypass port Z of the transmission destination processing unit PU(xd,yd). Accordingly, the undesired bypass communication path between the transmission source processing unit PU(xs,ys) and the transmission destination processing unit PU(xd,yd) may be deleted.

Next, an information processing method of the information processing device 101 will be described with reference to FIG. 11. In the information processing device 101, the CPU 111 executes a program in the RAM 112 and may thereby perform the process of FIG. 11.

In step S1100, the CPU 111 generates the respective routing tables 400 of the processing units PU of the reconfigurable circuit 102 that has no bypass communication path and performs control for writing the routing tables 400 in the RAMs 202 of the respective processing units PU. Then, the CPU 111 performs control for resetting all the communication amount tables 1200 in the RAMs 202 of the respective processing units PU to 0. Accordingly, the control unit 122 writes the routing tables 400 in the RAMs 202 of the respective processing units PU and resets all the communication amount tables 1200 in the RAMs 202 of the respective processing units PU to 0. Further, the CPU 111 resets the processing timer value to 0. The timer 114 starts counting-up of the processing timer value.

Next, in step S1101, the CPU 111 outputs a processing start instruction that includes the FPGA configuration data of the circuit information (including the communication path information) to the reconfigurable circuit 102. As illustrated in FIG. 1, the communication paths in the initial state where no bypass communication path is present are formed in the processing unit array 121. Each of the processing units PU starts data processing and communication.

Further, the CPU 111 controls each of the processing units PU such that each of the processing units PU starts measurement of the communication amount and update of the communication amount table 1200. Each of the processing units PU starts the measurement of the communication amount and the update of the communication amount table 1200.

Next, in step S1102, the CPU 111 stands by until the specific time TA elapses on the processing timer value and moves the process to step S1103 in a case where the specific time TA has elapsed.

In step S1103, the CPU 111 acquires the communication amount (communication cost) tables 1200 of the respective processing units PU and generates the communication amount table 1300. Then, the CPU 111 multiplies each of the communication amounts of the communication amount table 1300 by the coefficient α in accordance with the distance d of the coefficient table 1400, corrects each of the communication amounts of the communication amount table 1300, and writes the communication amount table 1300 in the RAM 112.

Next, in step S1104, the CPU 111 assesses whether or not the bypass communication path is present in the processing unit array 121. In the initial state, the CPU 111 assesses that no bypass communication path is present and moves the process to step S1106.

In step S1106, the CPU 111 acquires the maximum communication amount DD((xs,ys),(xd,yd)) among the communication amounts (communication costs) in the communication amount table 1300. Next, the CPU 111 assesses whether or not the maximum communication amount DD((xs,ys),(xd,yd)) is larger than the first threshold value and moves the process to step S1107 in a case where the maximum communication amount DD((xs,ys),(xd,yd)) is larger than the first threshold value but moves to step S1110 in a case where the maximum communication amount DD((xs,ys),(xd,yd)) is smaller than the first threshold value.

In step S1107, the CPU 111 assesses whether or not it is possible to add the bypass communication path between the bypass port Z of the transmission source processing unit PU(xs,ys) and the bypass port Z of the transmission destination processing unit PU(xd,yd), which correspond to the maximum communication amount DD((xs,ys),(xd,yd)). The CPU 111 moves the process to step S1109 in a case where the CPU 111 assesses that it is possible to add bypass communication path but moves to step S1108 in a case where the CPU 111 assesses that it is not possible to add bypass communication path.

In step S1108, the CPU 111 assesses whether or not a next candidate for the bypass communication path is present. Specifically, the CPU 111 acquires the second largest communication amount DD((xs,ys),(xd,yd)) among the communication amounts in the communication amount table 1300 as the next candidate. Next, the CPU 111 assesses whether or not the second largest communication amount DD((xs,ys),(xd,yd)) is larger than the first threshold value and returns the process to step S1107 in a case where the second largest communication amount DD((xs,ys),(xd,yd)) is larger than the first threshold value but moves to step S1110 in a case where the second largest communication amount DD((xs,ys),(xd,yd)) is smaller than the first threshold value. In step S1107, the CPU 111 assesses whether or not it is possible to add the bypass communication path to the next candidate.

In step S1109, the CPU 111 generates the FPGA configuration data, in which the bypass communication path is added between the bypass port Z of the transmission source processing unit PU(xs,ys) and the bypass port Z of the transmission destination processing unit PU(xd,yd), and moves the process to step S1110.

In step S1110, the CPU 111 assesses whether or not the dynamic reconfiguration is performed for the reconfigurable circuit 102. Then, the CPU 111 moves the process to step S1111 in a case where the CPU 111 assesses that the dynamic reconfiguration is performed but moves the process to step S1113 in a case where the CPU 111 assesses that the dynamic reconfiguration is not performed.

In step S1111, the CPU 111 outputs the FPGA configuration data, in which the bypass communication path is added, to the reconfigurable circuit 102. Then, the control unit 122 writes the FPGA configuration data in the processing unit array 121. Accordingly, in the processing unit array 121, the bypass communication path is added between the bypass port Z of the transmission source processing unit PU(xs,ys) and the bypass port Z of the transmission destination processing unit PU(xd,yd).

Next, in step S1112, the CPU 111 updates the routing tables 400 of the respective processing units PU as illustrated in FIG. 6 in accordance with the addition of the above bypass communication path. Then, the CPU 111 performs control such that the routing tables 400 are written in the RAMs 202 of the respective processing units PU. Subsequently, the CPU 111 moves the process to step S1113.

In step S1113, the CPU 111 controls the reconfigurable circuit 102 such that all the communication amounts of the communication amount table 1200 of each of the processing units PU are reset to 0. The control unit 122 resets all the communication amounts of the communication amount table 1200 in the RAM 202 of each of the processing units PU to 0. Further, the CPU 111 resets the processing timer value to 0 and returns the process to step S1102.

In step S1102, the CPU 111 stands by until the specific time TA elapses on the processing timer value and moves the process to step S1103 in a case where the specific time TA has elapsed. In step S1103, the CPU 111 acquires the communication amount tables 1200 of the respective processing units PU and generates the communication amount table 1300. Then, the CPU 111 multiplies each of the communication amounts of the communication amount table 1300 by the coefficient α in accordance with the distance d of the coefficient table 1400, corrects each of the communication amounts of the communication amount table 1300, and writes the communication amount table 1300 in the RAM 112.

Next, in step S1104, the CPU 111 assesses whether or not the bypass communication path is present in the processing unit array 121. In a case where the bypass communication path is present, the CPU 111 assesses whether or not the bypass communication path is deleted. Specifically, in a case where the bypass communication path is added between the transmission source processing unit PU(xs,ys) and the transmission destination processing unit PU(xd,yd), the CPU 111 refers to the communication amount table 1300 and assesses whether or not the communication amount DD((xs,ys),(xd,yd)) between the transmission source processing unit PU(xs,ys) and the transmission destination processing unit PU(xd,yd) is smaller than the second threshold value. Then, the CPU 111 moves the process to step S1105 in a case where the CPU 111 assesses that the communication amount DD((xs,ys),(xd,yd)) is smaller than the second threshold value but moves the process to step S1106 in a case where the CPU assesses that the communication amount DD((xs,ys),(xd,yd)) is larger than the second threshold value. The processes of step S1106 and subsequent steps are similar to the above.

In step S1105, the CPU 111 generates the FPGA configuration data, in which the bypass communication path between the bypass port Z of the transmission source processing unit PU(xs,ys) and the bypass port Z of the transmission destination processing unit PU(xd,yd) is deleted, and moves the process to step S1110.

In step S1110, the CPU 111 assesses that the dynamic reconfiguration is performed in a case where the FPGA configuration data, in which the bypass communication path is deleted, are generated in step S1105 but assesses that the dynamic reconfiguration is not performed in a case where the FPGA configuration data, in which the bypass communication path is deleted, are not generated. The CPU 111 moves the process to step S1111 in a case where the CPU 111 assesses that the dynamic reconfiguration is performed but moves the process to step S1113 in a case where the CPU 111 assesses that the dynamic reconfiguration is not performed.

In step S1111, the CPU 111 outputs the FPGA configuration data, in which the bypass communication path is deleted, to the reconfigurable circuit 102. Then, the control unit 122 writes the FPGA configuration data in the processing unit array 121. Accordingly, in the processing unit array 121, the bypass communication path between the bypass port Z of the transmission source processing unit PU(xs,ys) and the bypass port Z of the transmission destination processing unit PU(xd,yd) is deleted.

Next, in step S1112, the CPU 111 updates the routing tables 400 of the respective processing units PU as illustrated in FIG. 4 in accordance with the deletion of the bypass communication path. Then, the CPU 111 performs control such that the routing tables 400 are written in the RAMs 202 of the respective processing units PU. Then, the control unit 122 performs control such that the routing tables 400 are written in the RAMs 202 of the respective processing units PU. Subsequently, the CPU 111 moves the process to step S1113. The processes of step S1113 and subsequent steps are similar to the above.

In this embodiment, the information processing device 101 may add the bypass communication path in a case where the communication amount is larger than the first threshold value. Accordingly, the communication speed among the processing units PU may be improved. Further, the information processing device 101 may delete the bypass communication path in a case where the communication amount is smaller than the second threshold value. Accordingly, an undesired bypass communication path may be deleted.

As described above, in the first and second embodiments, in step S1103, the CPU 111 acquires the respective communication costs of pieces of communication among plural processing units PU at each specific time TA. In the first embodiment, the communication cost is the communication time. In the second embodiment, the communication cost is the communication amount. Specifically, in the second embodiment, the communication cost is the cost in accordance with the communication amount and the distance d between the processing units PU.

In steps S1106 to S1109, the CPU 111 performs control so as to add the bypass communication path for connecting the processing units PU, for which the communication cost is higher than the first threshold value. Note that the CPU 111 may perform control so as to add the bypass communication path for connecting the processing units PU, for which the communication time is longer than the first threshold value or the communication amount is larger than the first threshold value. Further, the CPU 111 may perform control so as to add the bypass communication path for connecting the processing units PU, for which the communication time is longer than the first threshold value and the communication amount is larger than the first threshold value.

In step S1108, in a case where the bypass communication path may not be added between the processing units PU, for which the communication cost is the maximum and is higher than the first threshold value, the CPU 111 performs control so as to add the bypass communication path for connecting the processing units PU, for which the communication cost is the second highest and is higher than the first threshold value.

In steps S1104 and S1105, the CPU 111 performs control so as to delete the bypass communication path in a case where the communication cost between the processing units PU, between which the bypass communication path is connected, is lower than the second threshold value. Note that the CPU 111 may perform control so as to delete the bypass communication path in a case where the communication time between the processing units PU, between which the bypass communication path is connected, is shorter than the second threshold value or the communication amount between those processing units PU is smaller than the second threshold value. Further, the CPU 111 may perform control so as to delete the bypass communication path in a case where the communication time between the processing units PU, between which the bypass communication path is connected, is shorter than the second threshold value and the communication amount between those processing units PU is smaller than the second threshold value.

The information processing device 101 may add the bypass communication path in a case where the communication cost is higher than the first threshold value. Accordingly, the communication speed among the processing units PU may be improved. Further, the information processing device 101 may delete the bypass communication path in a case where the communication cost is lower than the second threshold value. Accordingly, an undesired bypass communication path may be deleted.

Note that each of the processing units PU may have two or more bypass ports Z. Note that the processing unit array 121 is not limited to be provided with one bypass communication path but may be provided with two or more bypass communication paths.

The embodiments may be realized by execution of a program by a computer. Further, a computer-readable recording medium that records the above program and a computer program product such as the above program may be applied as embodiments of the present disclosure. As the recording medium, for example, a flexible disk, a hard disk, an optical disk, a magneto-optical disk, a CD-ROM, a magnetic tape, a non-volatile memory card, a ROM, or the like may be used.

Note that all the above embodiments only represent specific examples for carrying out the present disclosure, and the technical scope of the present disclosure is not to be construed as being limited by those examples. That is, the present disclosure may be practiced in various modes without departing from the technical ideas or main features of the present disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device for controlling a communication path among a plurality of processing units, the information processing device comprising:
a memory; and
a processor coupled to the memory and configured to
execute an acquiring process that includes acquiring communication cost of communication paths among the plurality of processing units, and
execute an adding control process that includes performing control to add a bypass communication path which connects a first processing unit and a second processing unit, each of the first and second processing unit being any of the plurality of processing units, and the communication cost of a communication path between the first and second processing units being higher than a first threshold value.

2. The information processing device according to claim 1, wherein
the processor is further configured to execute a deleting control process that includes performing control to delete the bypass communication path between the first processing unit and the second processing unit when the communication cost between the first processing unit and the second processing unit is smaller than a second threshold value.

3. The information processing device according to claim 1, wherein
the acquiring process includes acquiring the communication cost at each specific period.

4. The information processing device according to claim 1, wherein
the processor is further configured to execute a table control process that includes:
generating a routing table which indicates, with respect to each of the plurality of processing units, a distance from a subject processing unit to other processing unit in response to a communication path which connects the plural processing units, each of the subject processing unit and the other processing unit is any of the plurality of processing units;
updating the routing table when the bypass communication path is added; and
supplying the routing table to at least a part of the plurality of processing unit for decision of a route in which the processing units performs communication.

5. The information processing device according to claim 4, wherein
the distance indicated by the routing table is a logical distance from the subject processing unit to the other processing unit.

6. The information processing device according to claim 1, wherein
the communication cost of a communication path between the first processing unit and the second processing unit is a maximum and is higher than the first threshold value;
the adding control process includes performing, when the bypass communication path is not capable of being added between the first processing unit and the second processing unit, control to add the bypass communication path which connects a third processing unit and a fourth processing unit, each of the third processing unit and the fourth processing unit being any of the plurality of processing units, and the communication cost of a communication path between the third processing unit and the fourth processing unit being the second highest and being higher than the first threshold value.

7. The information processing device according to claim 1, wherein
the communication cost is determined by a communication time or a communication amount.

8. The information processing device according to claim 1, wherein
the communication cost is determined by a cost that corresponds to a communication amount and a distance between the processing units.

9. The information processing device according to claim 1, wherein
each of the plural processing units has
a port that is connected with a neighboring processing unit, and
a bypass port that is connected with the bypass communication path.

10. The information processing device according to claim 1, wherein
the plurality processing units are arranged in two dimensional grid,
each of the plural processing units includes
a first port configured to be connected with a neighboring processing unit on an upper side,
a second port configured to be connected with the neighboring processing unit on a right side,
a third port configured to be connected with the neighboring processing unit on a lower side,
a fourth port configured to be connected with the neighboring processing unit on a left side, and
a bypass port configured to be connected with the bypass communication path.

11. A method performed by a computer for controlling a communication path among a plurality of processing units, the method comprising:
executing an acquiring process that includes acquiring communication cost of communication paths among the plurality of processing units; and
executing an adding control process that includes performing control to add a bypass communication path which connects a first processing unit and a second processing unit, each of the first and second processing unit being any of the plurality of processing units, and the communication cost of a communication path between the first and second processing units being higher than a first threshold value.

12. A non-transitory computer-readable storage medium for storing a program for controlling a communication path among a plurality of processing units, the program causing a processor to execute a process, the process comprising:
executing an acquiring process that includes acquiring communication cost of communication paths among the plurality of processing units; and
executing an adding control process that includes performing control to add a bypass communication path which connects a first processing unit and a second processing unit, each of the first and second processing unit being any of the plurality of processing units, and the communication cost of a communication path between the first and second processing units being higher than a first threshold value.
